(19) United States
(12) Patent Application Publication
(10) Pub. No.: US 2006/0177189 A1
(43) Pub. Date: Aug. 10, 2006

(54) Core detaching tool for optical fiber cable and method of detaching optical fiber cores from optical fiber cable

(75) Inventors: Yoshinori Kurosawa, Hitachi (JP); Mikio Ohkoshi, Hitachi (JP); Yoshihiro Kodaka, Kitaibaraki (JP); Takahiro Sato, Hitachi (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: HITACHI CABLE, LTD., Tokyo (JP)

(21) Appl. No.: 11/349,117

(22) Filed: Feb. 8, 2006

(30) Foreign Application Priority Data
Feb. 9, 2005 (JP) 2005-033670

(51) Int. Cl. G02B 6/00

(52) U.S. Cl. 385/134; 385/136; 385/147

(57) ABSTRACT

A core detaching tool for an optical fiber cable detaches one or more optical fiber tape units accommodated in a sheath of the optical fiber cable by tearing the sheath. The core detaching tool for an optical fiber cable is provided with a pair of cable holding parts, and a moving mechanism for moving the cable holding parts. A pair of projected parts are formed inside the cable holding parts, and a distance between the projected parts is greater than a long side face of a cross section of the optical fiber tape unit. The optical fiber tape unit can be separated and detached from the sheath in intermediate post-branching of the optical fiber cable without increasing a transmission loss.

The present application is based on Japanese Patent Application No. 2005-033670 filed on Feb. 9, 2005, the entire contents of which are incorporated herein by reference.

### BACKGROUND OF THE INVENTION

1. Field of the Invention

The present invention relates to a core detaching tool for an optical fiber cable and a method of detaching optical fiber cores from an optical fiber cable, in more particularly to a core detaching tool for an optical fiber cable and a method for detaching (taking out) optical fiber cores from the optical fiber cable having a substantially rectangular cross section by tearing a sheath of the optical fiber cable.

2. Description of the Related Art

FIG. 1 shows a configuration of a conventional optical fiber cable, which is disclosed by Japanese Patent Laid-Open No. 2003-295011 (JP-A-2003-295011). In an optical fiber cable 100 shown in FIG. 1, a pair of tension members (tensile strength resistant members) 111 comprising a conductive metal wire or a non-conductive metal wire such as glass fiber, plastic, etc. are provided along both of upper and lower sides of two pieces of optical fiber tape units 110 that are layered. A cable part 114 comprises a pair of the optical fiber tape units 110 and the tension members 111 covered collectively with a cable part sheath 112 made of a thermoplastic resin such as PE, fire-resistant PE, or PVC. In addition, a supporting wire part 117 comprises a supporting wire 115 made of a metal wire, e.g. a steel wire, and a supporting wire part sheath 116 made of a thermoplastic resin such as PE, fire-resistant PE, or PVC for covering the supporting wire 115. The cable part 114 and supporting wire part 117 are connected in parallel with each other by a constricted neck portion 118. Further, a pair of notches 113 for splitting the optical fiber cable 100 is provided on side faces of the sheath 112 to take out (detach) the optical fiber tape units 110.

FIGS. 2A to 2E show a conventional core detaching tool for an optical fiber cable and a process for taking out (detaching) cores using the conventional core detaching tool. The conventional core detaching tool is a “drop detacher” manufactured by Sumiden High Precision Co., Ltd. This detacher comprises a pair of cable holding parts 220. The cable holding parts 220 are configured in accordance with dimensions of the cable part (optical fiber cable) 114 separated from the supporting wire part 117, which has a substantially rectangular cross section as shown in FIG. 1. Each of the cable holding parts 220 is openable and closable, and provided with an engaging tab 221 at its tip end. The cable holding part 220 in a longitudinal direction of the cable of is 10 mm. The engaging tab 221 has a cross section substantially equal to a half of a cross section of a notch 113 for splitting a cable.

In FIGS. 2A, 2B and 2C, the core detaching tool 200 comprises a pair of members each having a hand lever 223, a central portion 240, and an actuating portion 230, wherein the central portions 240 are operatively connected by an axial pin 225, and the hand levers 223 are forcedly opened by a spring member 226, so that the actuating portions 230 are forcedly closed. The actuating portions 230 are provided with opening and closing levers 222 each having an engaging tab 221, and provide a space for accommodating the cable holding part 220.

In FIGS. 2D and 2E, the cable holding part 220 comprises a pair of main members 232 each having an engaging tab 234 at a tip end thereof and a concave portion 235, and a pair of finger members 233 each having an engaging tab 221 at a tip end thereof, wherein the concave portions 235 provide a space for accommodating the cable part 114.

Further, the process of taking out (detaching) cores is as follows. The cable part (optical fiber cable) 114 is installed into the cable holding parts 220, both of the opening and closing levers 222 are closed, so as to insert the engaging tabs 221, 234 into the notches 113 for splitting a cable of the cable part (optical fiber cable) 114. Thereafter, the hand levers 223 are closed, so that both the cable holding parts 220 move to the outside to be separated from each other, i.e. toward opposite directions. As a result, the cable part sheath 112 is divided into two parts from the notches 113 for splitting a cable as a starting point. The conventional core detaching tools are disclosed by Japanese Patent Laid-Open Nos. 11-133242 (JP-A-11-133242) and 2000-121839 (JP-A-2000-121839).

In accordance with expansion of demand for the FTTH (Fiber to The Home), it has been required to apply a method comprising steps of installing an optical fiber cable, branching the optical fiber cable at an intermediate part, and taking out an optical fiber tape unit from the optical fiber cable (hereinafter, referred as “intermediate post-branching method”).

However, when the intermediate post-branching method is conducted by using the conventional core detaching tool, there is a disadvantage in that a transmission loss is increased and the optical fiber tape unit is damaged, by the operation for taking out (detaching) the cores from the optical fiber cable.

In FIGS. 2A to 2E, the optical fiber tape unit 110 can be independently separated at a center part. However, in the conventional core detaching tool 200, the cable holding part 220 has a length of 10 mm in the longitudinal direction of the optical fiber cable 100. Therefore, when the cable 100 is torn up for more than 10 m in a direction perpendicular to the longitudinal direction of the optical fiber cable 100, both sides of the cable part sheath 112 are bent to the outside. Further, a surplus length is generated in the optical fiber tape unit 110, so that the optical fiber tape unit 110 is bent in a tape thickness direction due to its cross sectional configuration. At this time, an increase in the transmission loss for more than 1 dB is occurred due to the bending.

In addition, in the conventional core detaching tool 200, the optical fiber tape unit 110 may not be always independently separated at the center part as shown in FIGS. 2A to 2E.

FIGS. 3A and 3B show failure examples for detaching the optical fiber tape units comprising cores.

In the conventional core detaching method, the cable part sheath 112 is torn up by pressing with the engaging tabs 221 over the notches 113 for splitting a cable located at a center part of the optical fiber cable 100. As shown in FIG. 3A, the optical fiber tape unit 110 may be separated from one side of the cable part sheath 112 while being attached (sandwiched) to another side of the cable part sheath 112. For this case, since the optical fiber tape unit 110 is bent to a width direction of the optical fiber tape unit 110, a surplus length is generated in cores located inside a curve, thereby causing meandering of the cores. As a result, the transmission loss is increased for more than 1 dB.

On the other hand, when a suppress strength i.e. grasping force applied by the engaging tabs 221 is too large, the optical fiber tape unit 110 is torn up and the cores are separated as shown in FIG. 3B.

### SUMMARY OF THE INVENTION

It is an object of the invention to provide a core detaching tool for an optical fiber cable and a method of detaching the optical fiber cores from an optical fiber cable, for solving the aforementioned problems, in which an optical fiber tape unit can be separated and detached from a cable part sheath in intermediate post-branching of the optical fiber cable, without increasing a transmission loss.

According to a first feature of the invention, a core detaching tool for an optical fiber cable, comprises:

a pair of cable holding parts for holding the optical fiber cable comprising one or more optical fiber tape units accommodated in a sheath of the optical fiber cable;

a pair of projected parts formed inside the cable holding parts, a distance between the projected parts being greater than a long side face of a cross section of the optical fiber tape unit; and

a moving mechanism for moving the cable holding parts, thereby tearing the sheath to detach the optical fiber tape units.

In the core detaching tool for an optical fiber cable, it is preferable that a length of the cable holding part in a longitudinal direction of the optical fiber cable is from 20 to 50 mm.

Further, in the core detaching tool for an optical fiber cable, the moving mechanism may comprise a pair of actuating portions between which a space is formed to accommodate the pair of cable holding parts, and a pair of hand levers to open and close the pair of actuating portions.

According to a second feature of the invention, a method of detaching one or more optical fiber tape units accommodated in a sheath of an optical fiber cable, comprises the steps of:

providing the sheath having first and second side faces on which first and second main notches, first and second auxiliary notches, and third and fourth auxiliary notches are formed, respectively, a line connecting the first and second main notches being across the optical fiber tape units, a line connecting the first and second auxiliary notches being off one side of the optical fiber tape units, and a line connecting the third and fourth auxiliary notches being off another side of the optical units;

engaging first and second pairs of tabs with the first to fourth auxiliary notches; and

pulling the first and second pairs of tabs in opposite directions, whereby the sheath is split along the line connecting the first and second main notches to detach the optical fiber tape units.

In the method of detaching one or more optical fiber tape units accommodated in a sheath of an optical fiber cable, the step of providing the sheath may comprise a step of forming the first and second main notches to be deeper than the first to fourth auxiliary notches.

The inventors have found that the problem of the conventional core detaching tool are caused by that the length of the cable holding parts in the longitudinal direction is short, and that the optical fiber tape unit is pressed by the engaging tabs of the cable holding parts.

According to the present invention, since a distance (in interval) between projected parts provided on the cable holding parts is greater than a length of a long side face of a cross section of the optical fiber tape unit, the suppress strength applied by the projected parts can be reduced when the cable is grasped by the cable holding parts. Therefore, the optical fiber tape unit can be separated easily from the cable part sheath.

In addition, according to the present invention, the length of the cable holding part in the longitudinal direction of the cable is from 20 to 50 mm, so that it is possible to suppress a bending of the optical fiber tape unit when the cable part sheath is torn up. As a result, the increase in the transmission loss can be suppressed.

As described above, according to the present invention, the intermediate post-branching of the optical fiber cable can be realized without damaging the optical fiber tape unit and without increasing the increase of the transmission loss.

### BRIEF DESCRIPTION OF THE DRAWINGS

Next, preferred embodiment according to the present invention will be explained in conjunction with appended drawings, wherein:

FIG. 1 is a cross sectional view showing a conventional optical fiber cable;

FIGS. 2A to 2E are explanatory diagrams showing a conventional core detaching tool for an optical fiber cable and a method of detaching cores using the conventional core detaching tool at the time of intermediate post-branching;

FIGS. 3A and 3B are explanatory diagrams showing failure examples for detaching the cores using the conventional core detaching tool for an optical fiber cable;

FIGS. 4A to 4E are explanatory diagrams showing a core detaching tool for an optical fiber cable in a preferred embodiment according to the invention and a method of detaching the cores using the core detaching tool at the time of intermediate post-branching;

FIG. 5 is a cross sectional view showing an optical fiber oable in a first preferred embodiment according to the invention; and

FIG. 6 is a side view showing a core detaching tool for an optical fiber cable in the preferred embodiment according to the invention.

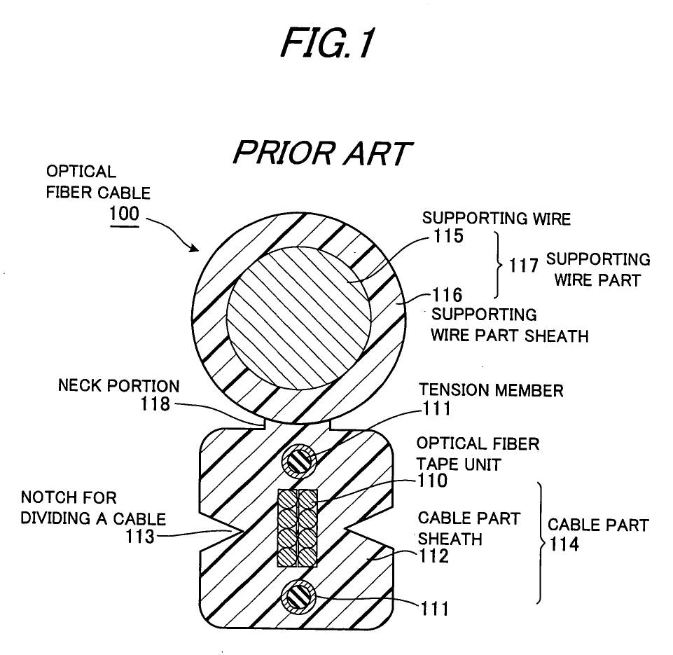

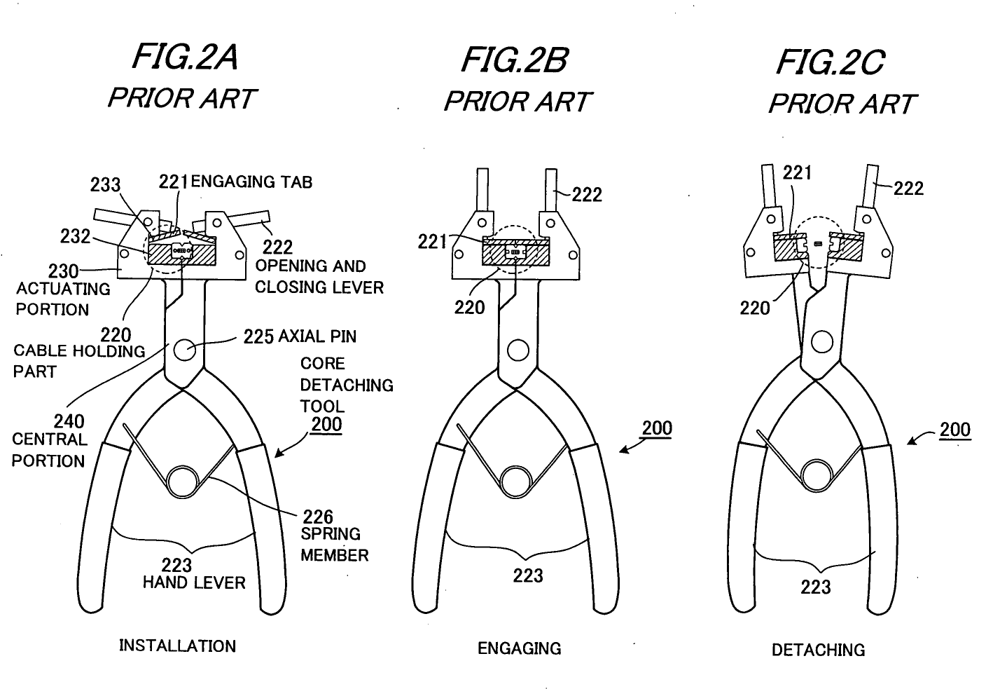

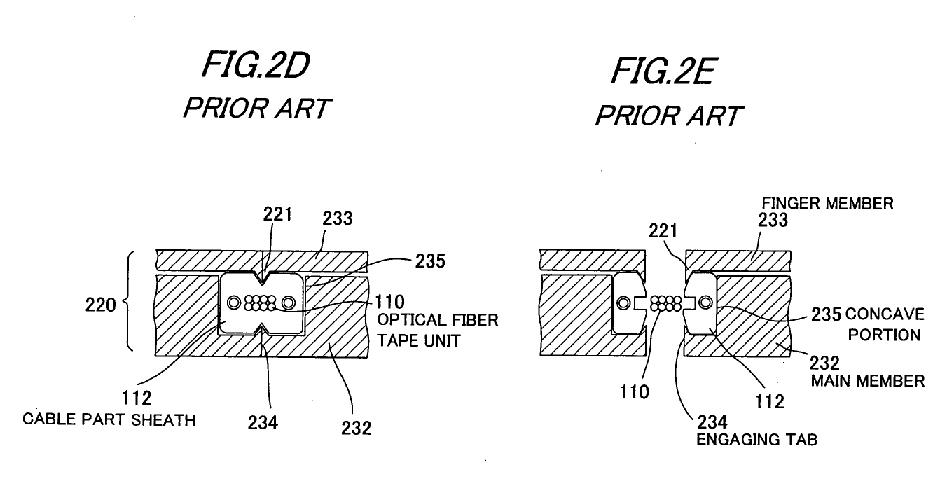

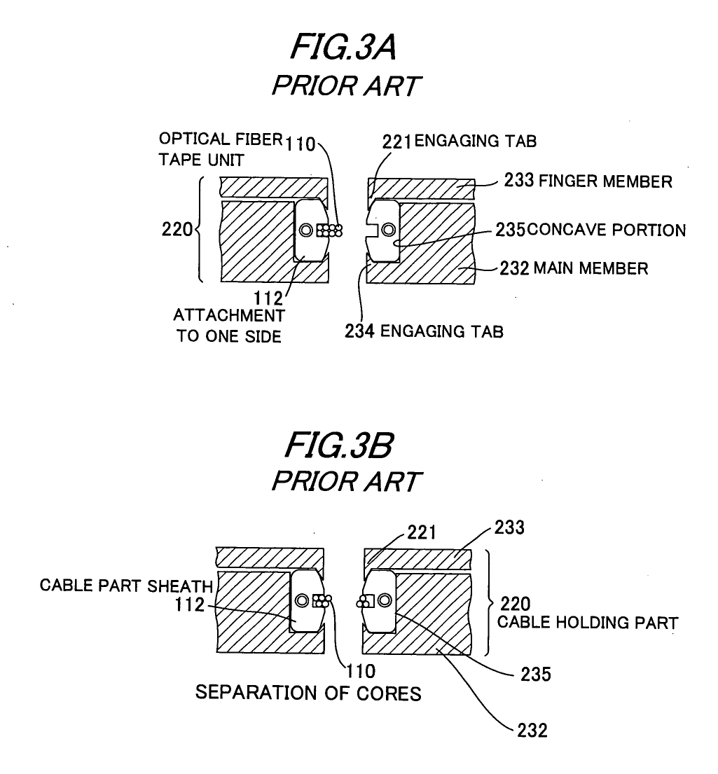

### DESCRIPTION OF THE PREFERRED EMBODIMENTS

Next, the preferred embodiment according to the present invention will be explained in conjunction with the appended drawings.

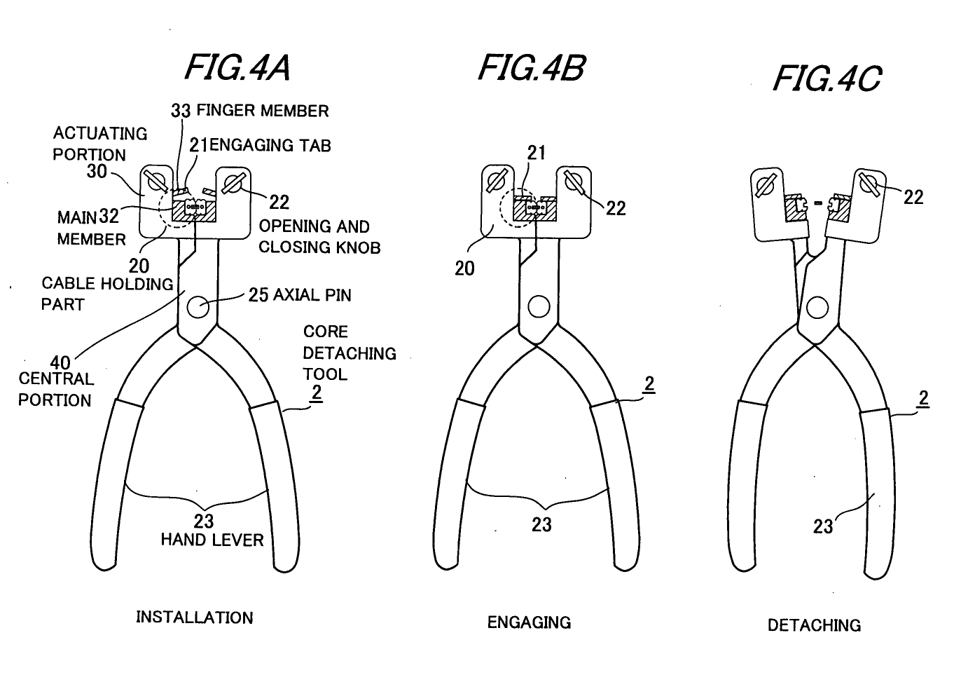

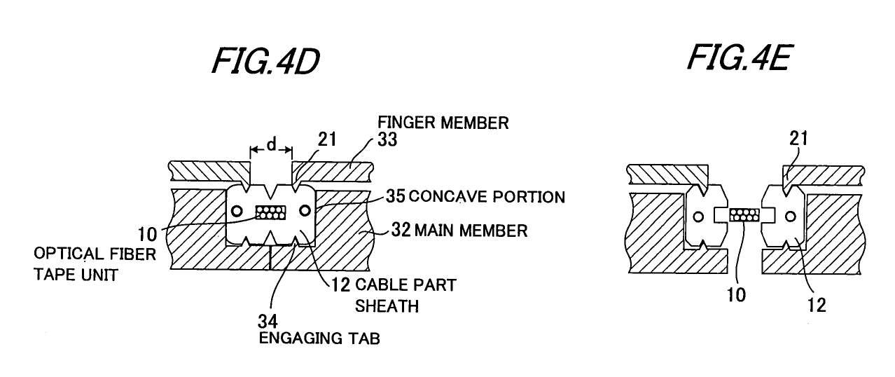

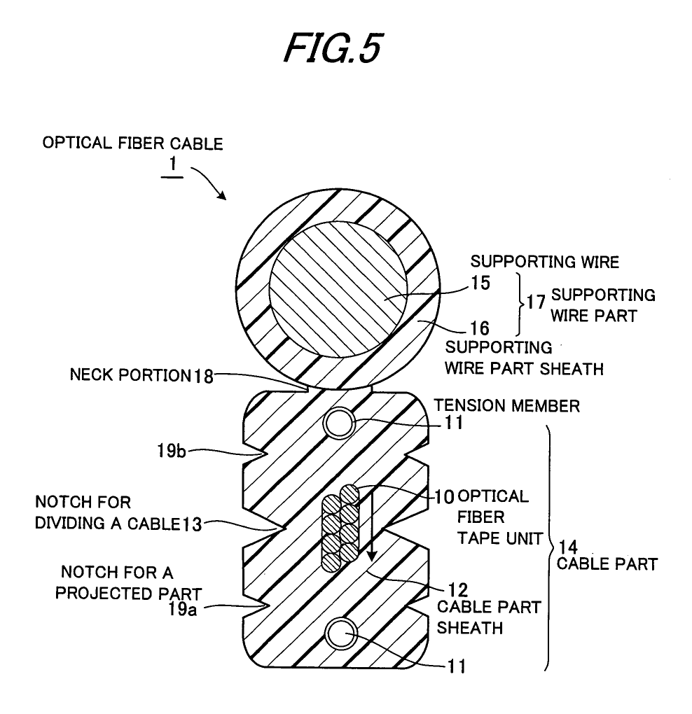

FIGS. 4A to 4E show a core detaching tool for an optical fiber cable in a preferred embodiment according to the invention and a method of detaching cores using the core detaching tool at the time of intermediate post-branching.

Further, FIG. 5 is a cross sectional view showing an optical fiber cable in the first preferred embodiment.

In FIGS. 4A, 4B and 4C, the core detaching tool 2 comprises a pair of members each having a hand lever 23, a central portion 40, and an actuating portion 30, wherein the central portions 40 are operatively connected by an axial pin 25, and the hand levers 23 are forcedly opened, so that the actuating portions 30 are forcedly closed. The actuating portions 30 are provided with opening and closing knobs 22 each having an engaging tab 21, and provide a space for accommodating the cable holding part 20.

The core detaching tool 2 for an optical fiber cable shown in FIGS. 4A to 4E comprises a pair of cable holding parts 20, which are configured in accordance with dimensions of the cable part (optical fiber cable) 14 having a substantially rectangular cross section as shown in FIG. 5. Each of the cable holding parts 20 is openable and closable, and provided with a projected part (for example, an engaging tab) 21 at its tip end. A moving mechanism for moving the cable holding parts 20 is configured to have a pair of the cable holding parts 20 at tip ends of the hand levers 23, such that the cable holding parts 20 can be opened and closed.

As shown in FIGS. 4D and 4E, the cable holding part 20 comprises a pair of main members 32 each having an engaging tab 34 at a tip end thereof and a concave portion 35, and a pair of finger members 33 each having an engaging tab 21 at a tip end thereof, wherein the concave portions 35 provide a space for accommodating the cable part 14.

In FIG. 4D, the pair of finger members 33 has a gap of a distance d therebetween larger than a width of an optical fiber tape unit 10, and the pair of main members 32 each having an engaging tap 34, wherein the engaging tabs 34, 34 have a gap of the distance d therebetween.

Further, a well known opened plier system may be used, in which the cable holding parts 20 are opened when the hand levers 23 are griped to narrower a distance therebetween. The present invention is not limited to the preferred embodiment, and a closed plier may be also used. In addition, means for tearing the optical fiber cable is not limited to grip-type hand levers. For example, a commercialized moving/sliding mechanism such as a slide rail, a linear guide may be used. As a power used for tearing up the optical fiber cable, an electric motor, etc. may be used.

In the present invention, following two technical improvements are realized for solving the problems of the conventional core detaching tool.

(1) So as to prevent a deviation of the optical fiber tape unit and a core separation during the separation from the sheath, portions generating a main suppress strength, such as projected parts (e.g. engaging tabs) of cable holding parts, are positioned more outwardly than an area corresponding to the optical fiber tape unit. According to this structure, the suppress strength is not applied to the optical fiber tape unit via a cable part sheath. Therefore, the optical fiber tape unit can be easily separated from the cable part sheath, and can be independently separated at a center part.

(2) Even though the optical fiber tape unit is independently separated at a center part, a transmission loss may be increased. As described above, the reason is assumed as follows. When the length of the cable holding part in the longitudinal direction of the cable is not enough for a tearing stroke, the optical fiber tape unit independently separated from the sheath is bent in a thickness direct-ion of the optical fiber tape unit. As a result, the transmission loss is increased due to the bending of the optical fiber tape unit. After studying the length of the cable holding part in the longitudinal direction of the cable in various ways, the Inventors found that an optimized length thereof is from 20 to 50 mm.

Further, a cable part sheath configuration of the optical fiber cable is changed in accordance with the configuration of the core detaching tool in the present invention.

FIG. 5 shows an optical fiber cable in a preferred embodiment used for the present invention. In the optical fiber cable 1 shown in FIG. 5, two additional notches 19a and 19b for projected parts are provided in parallel at a long side face of a cable part sheath 12, in addition to a notch 13 for splitting a cable. The notch 13 for splitting a cable is provided for taking out (detaching) an optical fiber tape unit 10. The notches 19a, 19b for projected parts are provided at positions corresponding to projected parts 21 (e.g. engaging tabs) of cable holding parts 20.

In concrete, the optical fiber cable 1 comprises a cable part 14 and a supporting wire part 17. The cable part 14 comprises a cable part sheath 12 accommodating optical fiber tape units 10, and a pair of tension members 11 disposed on both sides of the optical fiber tape units 10. The supporting wire part 17 comprises a supporting wire part sheath 16 provided on an outer periphery of a supporting wire 15. The cable part 14 and supporting wire part 17 are connected with each other via a neck portion 18. As shown in FIG. 5, the notches 19a and 19b for projected parts are formed at the long side face of the sheath 12. As shown in FIG. 4D, a distance d between the projected parts 21, 21 is greater than a width of the optical fiber tape unit 10. The notch 13 for splitting a cable is formed between the notches 19a and 19b for projected parts.

An operation process for detaching the cores is similar to that in the conventional art. As shown in FIGS. 4A to 4E, the optical fiber cable 1 is installed in the cable holding parts 20, and both of opening and closing knobs 22 are closed to insert the projected parts 21, 21 into notches 19a, 19b for projected parts of the optical fiber cable 1. At this time, the suppress strength is applied to the cable part sheath 12, mainly on the projected parts 21. However, the suppress strength is not applied to the optical fiber tape unit 10, since the notches 19a, 19b for projected parts are positioned outside the optical fiber tape unit 10, i.e., the notches 19a, 19b are distant from an area corresponding to the optical fiber tape unit 10. When the hand levers 23 are closed, both of the cable holding parts 20 move to directions to be separated from each other to the outside, i.e. to the opposite directions. As a result, the cable part sheath 12 is divided into two parts from the notch 13 for splitting a cable, and the optical fiber tape unit 10 can be independently separated from the cable part sheath 12 at a center part.

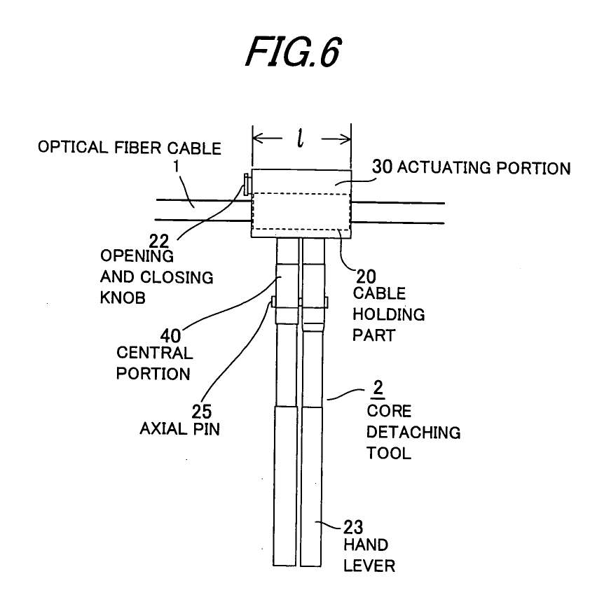

FIG. 6 is a side view showing a core detaching tool for an optical fiber cable in the preferred embodiment according to the invention.

A length l of the cable holding part 20 in a longitudinal direction of the cable 1 is closely related to the workability of the core detaching tool 2 and the increase in transmission loss of the cable 1.

Accordingly, the comprehensive evaluations are conducted for providing an optimized distance d between the engaging tabs 21 and an optimized length l of the cable holding part 20 in the longitudinal direction of the cable 1.

(1) Basis for providing a distance between projected parts (engaging tabs) greater than a long side length of a cross section of an optical fiber tape unit

TABLE 1 shows an evaluation result of an optimization of a distance dbetween engaging tabs 21, 21, using an optical fiber cable 1 incorporating four-core optical fiber tape unit 10 with an outside diameter of the optical fiber core being 0.5 mm. The length l of the cable holding part 20 in a longitudinal direction of the cable 1 is kept constant at 30 mm. Samples of engaging tab members having different distances d are manufactured. In the samples, the distance d between the engaging tabs 21, 21 is varied for every 1.0 mm from 0 mm (corresponding to the conventional core detaching tool) to 4.0 mm, and experiments for taking out (detaching) cores are conducted. The four-core optical fiber tape unit used in this optical fiber cable has a width of 1.0 mm.

In the conventional core detaching tool 200 having the distance d of 0 mm, a suppress strength applied to the notch 113 for splitting a cable at the center part of the cable part sheath 112 is strong, so that the transmission loss is increased as well as the cores in the optical fiber tape unit 110 is separated.

When the distance d between the engaging tabs 21 is 1.0 mm, which is equal to a width of the optical fiber tape unit 10, the suppress strength is applied in vicinity of both ends of the optical fiber tape unit 10. Although the cores in the optical fiber tape unit 10 are not separated from each other, the increase in the transmission loss for 3 to 6 dB is observed in the cores positioned at both ends of the optical fiber tape unit 10.

On the other hand, when the distance d between the engaging tabs 21, 21 is 2.0 mm or more, the separation of cores in the optical fiber tape unit 10 does not occur, and the increase in the transmission loss is less than 0.1 dB, that is considered to be harmless.

TABLE 1
Evaluation result of an optimization of a distance between
engaging tabs (Length of a holding part: 30 mm at constant)

| Tab distance d | Core | Generated loss | Comprehensive |
|---|---|---|---|
| (mm) | separation | (dB, @ 1.55 μm) | evaluation |
| 0 | Yes | from 5 to 10 | X |
| 1.0 | No | from 3 to 6 | X |
| 2.0 | No | Less than 0.1 | ◯ |
| 3.0 | No | Less than 0.1 | ◯ |
| 4.0 | No | Less than 0.1 | ◯ |

(2) Basis that an optimized length of a cable holding part in a longitudinal direction of a cable is from 20 to 50 mm

TABLE 2 shows an evaluation result of an optimization of a length l of a cable holding part in a longitudinal direction of a cable, using an optical fiber cable incorporating four-core optical fiber tape unit with an outside diameter of the optical fiber core being 0.5 mm. The length l of the cable holding part 20 in a longitudinal direction of the cable 1 is varied for every 10 mm from 10 mm to 60 mm, and the core detaching characteristics are comparatively evaluated. The distance dbetween the engaging tabs 21 and 21 is constantly 3.0 mm, which is greater than a width of the four-core optical fiber tape unit 10. As a result, in all samples, the separation or deviation of the cores are not observed.

However, when the length l of the cable holding part 20 is 10 mm, bending of the optical fiber tape unit 10 after tearing is great, so that a transmission loss of 4 to 8 dB due to the bending is occurred.

On the other hand, if the length l of the cable holding part 20 is increased, following two problems are caused.

The first problem is that a tearing force is increased in accordance with the increase in the length l of the cable holding part 20. The tearing force finally surpasses 200N when the length l is 60 mm. In case of using a hand lever type tool, a load of 200 N is within a range of hand gripping power, however, the tearing force at this level may be a noticeable load for an operator. In addition, if the load of 200N is charged every time on the core detaching tool, each parts such as a hinge of the core detaching tool will require a strength and a rigidity similar to those for a cutting pliers or nippers. Therefore, the increase in size and weight of the core detaching tool will be inevitable.

The second problem is that the optical fiber cable is not always straight, so that the operator has some difficulty to install the cable to the core detaching tool having a length 1 of 50 mm, and that the operator cannot install the cable in parallel to the core detaching tool having a length l of 60 mm without an assistant. For the reasons described above, the optimized length l of the cable holding part 20 in the longitudinal direction of the cable is from 20 to 50 mm.

TABLE 2
Evaluation result of an optimization of a length
1 of a cable holding part in a longitudinal direction
of a cable (Tab distance: 3 mm at constant)

| | | Generated | | |
|---|---|---|---|---|
| Holding part | Tearing | loss (dB, @ | Work- | Comprehensive |
| length l (mm) | force (N) | 1.55 μm) | ability | evaluation |
| 10 | 20 to 30 | from 4 to 8 | ◯ | X |
| 20 | 40 to 50 | Less than 0.1 | ◯ | ◯ |
| 30 | 70 to 90 | Less than 0.1 | ◯ | ◯ |
| 40 | 110 to 130 | Less than 0.1 | ◯ | ◯ |
| 50 | 160 to 180 | Less than 0.1 | Δ | ◯ |
| 60 | 200 or more | Less than 0.1 | X | X |

Although the invention has been described with respect to specific embodiment for complete and clear disclosure, the appended claims are not to be thus limited but are to be construed as embodying all modification and alternative constructions that may be occurred to one skilled in the art which fairly fall within the basic teaching herein set forth.

What is claimed is:

1. A core detaching tool for an optical fiber cable, comprising:
a pair of cable holding parts for holding the optical fiber cable comprising one or more optical fiber tape units accommodated in a sheath of the optical fiber cable;
a pair of projected parts formed inside the cable holding parts, a distance between the projected parts being greater than a long side face of a cross section of the optical fiber tape unit; and
a moving mechanism for moving the cable holding parts, thereby tearing the sheath to detach the optical fiber tape units.

2. The core detaching tool for an optical fiber cable, according to claim 1, wherein:
a length of the cable holding part in a longitudinal direction of the optical fiber cable is from 20 to 50 mm.

3. The core detaching tool for an optical fiber cable, according to claim 1, wherein:
the moving mechanism comprises a pair of actuating portions between which a space is formed to accommodate the pair of cable holding parts, and a pair of hand levers to open and close the pair of actuating portions.

4. A method of detaching one or more optical fiber tape units accommodated in a sheath of an optical fiber cable, comprising the steps of:
providing the sheath having first and second side faces on which first and second main notches, first and second auxiliary notches, and third and fourth auxiliary notches are formed, respectively, a line connecting the first and second main notches being across the optical fiber tape units, a line connecting the first and second auxiliary notches being off one side of the optical fiber tape units, and a line connecting the third and fourth auxiliary notches being off another side of the optical units;
engaging first and second pairs of tabs with the first to fourth auxiliary notches; and
pulling the first and second pairs of tabs in opposite directions, whereby the sheath is split along the line connecting the first and second main notches to detach the optical fiber tape units.

5. The method of detaching one or more optical fiber tape units accommodated in a sheath of an optical fiber cable, according to claim 4, wherein:
the step of providing the sheath comprises a step of forming the first and second main notches to be deeper than the first to fourth auxiliary notches.
